(19) United States
(12) Patent Application Publication
(10) Pub. No.: US 2024/0285462 A1
(43) Pub. Date: Aug. 29, 2024

(54) REHABILITATION SYSTEMS AND METHODS

(71) Applicant: President and Fellows of Harvard College, Cambridge, MA (US)

(72) Inventors: Conor J. Walsh, Cambridge, MA (US); Diogo Schwerz de Lucena, Cambridge, MA (US); Christina Glover, Cambridge, MA (US); Kristin Nuckols, Cambridge, MA (US); Maxwell Herman, Cambridge, MA (US); Diana Wagner, Cambridge, MA (US)

(73) Assignee: President and Fellows of Harvard College, Cambridge, MA (US)

(21) Appl. No.: 18/573,422

(22) PCT Filed: Jun. 22, 2022
(86) PCT No.: PCT/US2022/034508

§ 371 Date: Dec. 21, 2023

Related U.S. Application Data
(60) Provisional application No. 63/254,722, filed on Oct. 12, 2021.
(60) Provisional application No. 63/215,124, filed on Jun. 25, 2021.

(51) Int. Cl. A61H 1/02

(52) U.S. Cl. CPC A61H 1/0288; A61H 2201/1638; A61H 2201/5012; A61H 2201/5043; A61H 2230/605

(57) ABSTRACT

Rehabilitation systems and related methods are generally described. In some embodiments, a rehabilitation system may employ a flexible wearable robotic system which may be positioned on a user's appendage. The wearable robotic system may deform the appendage in a clinically relevant manner to facilitate rehabilitation of the appendage's motor function. In some embodiments, the wearable robotic system may include one or more sensors configured to measure the movement of the actuator based on its own actuation and/or the user's effort. The system may then convey such measurements to a processor for analysis and to a display to provide real-time feedback of the user's progress to the user and/or a clinician. In some embodiments, the actuator may be a glove.

### RELATED APPLICATIONS

This application claims the benefit of priority under 35 U.S.C. § 119(e) of U.S. Provisional Application Ser. No. 63/215,124, filed Jun. 25, 2021, and U.S. Provisional Application Ser. No. 63/254,722, filed Oct. 12, 2021, the disclosures of each of which are incorporated by reference herein in their entirety

### GOVERNMENT FUNDING

This invention was made with Government support under Grant No. 1830896 awarded by the National Science Foundation. The Government has certain rights in the invention.

### FIELD

The technology is generally related to rehabilitation systems and methods.

### BACKGROUND

According to the Center for Disease Control, approximately 795,000 individuals experience a stroke each year, resulting in an accumulation of an estimated 7.2 million survivors in the United States. Approximately 76% of survivors experience long-term disability following a stroke, resulting in approximately $54 billion in lost work and medical fees. These disabilities include impairment or loss of fine motor function, which can include operation of the hands and wrists. Lasting deficits to the hands can impair stroke survivors' quality of life, as tasks such as opening containers, using keys, operating mobile phones or computers, and getting dressed can become challenging or impossible.

### SUMMARY

In one aspect, rehabilitation systems are provided. In some embodiments, the rehabilitation system includes a flexible wearable robotic system configured to be worn on an appendage of a user, the flexible wearable robotic system including one or more compliant actuators configured to apply a force to one or more joints of the appendage; one or more sensors configured to sense one or more parameters related to movement of the appendage; and at least one processor operatively coupled with the one or more sensors and the one or more compliant actuators, wherein the at least one processor is configured to: operate the one or more compliant actuators to perform one or more rehabilitation activities, and output feedback related to the one or more parameters to a user using a display operatively coupled to the at least one processor.

In another aspect, methods of rehabilitation are provided. In some embodiments, the method of rehabilitation includes positioning a flexible wearable robotic system on an appendage of a user; operating one or more compliant actuators of the flexible wearable robotic system with at least one processor operatively coupled to the one or more compliant actuators to apply a force to one or more joints of the appendage to perform one or more rehabilitation activities; sensing one or more parameters related to movement of the appendage with one or more sensors of the flexible wearable robotic system; and outputting feedback related to the one or more parameters to a user using a display operatively coupled to the at least one processor.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows, according to some embodiments, a schematic of a rehabilitation system;

FIG. 2 shows, according to some embodiments, a schematic of a rehabilitation glove in a contracted configuration;

FIG. 3 shows, according to some embodiments, a rehabilitation glove in an extended configuration;

FIG. 4 shows, according to some embodiments, a flow chart for a method of assessing motor function;

FIG. 5A shows, according to some embodiments, a graphical interface on a display for a rehabilitation system;

FIG. 5B shows, according to some embodiments, a plot of bending angle of a rehabilitation glove as a function of time;

FIG. 6 shows, according to some embodiments, a flow chart for a method of assessing motor function;

FIG. 7A shows, according to some embodiments, a graphical interface on a display for a rehabilitation system;

FIG. 7B shows, according to some embodiments, a plot of bending angle and actuator pressure of a rehabilitation glove as a function of time;

FIG. 8 shows, according to some embodiments, a flow chart for a method of assessing motor function;

FIG. 9A shows, according to some embodiments, a graphical interface on a display for a rehabilitation system;

FIG. 9B shows, according to some embodiments, a plot of bending angle and actuator pressure of a rehabilitation glove as a function of time;

FIG. 10 shows, according to some embodiments, a flow chart for a method of assessing motor function;

FIG. 11 shows, according to some embodiments, a plot of bending angle of a rehabilitation glove as a function of time;

FIG. 12 shows, according to some embodiments, a flow chart for a method of assessing motor function;

FIGS. 13A-13B show, according to some embodiments, graphical interfaces on a display for a rehabilitation system;

FIG. 14 shows, according to some embodiments, a graphical interface on a display for a rehabilitation system;

FIG. 15 shows, according to some embodiments, a flow chart for a method of detecting operation of a rehabilitation glove;

FIG. 16 shows, according to some embodiments, a flow chart for a method of detecting operation of a rehabilitation glove; and

FIG. 17 shows, according to some embodiments, a plot of bending angle and actuator pressure of a rehabilitation glove as a function of time.

### DETAILED DESCRIPTION

An individual experiencing stroke (a condition in which the blood supply to an area of the brain is temporarily cut off) or other injuries or conditions (e.g., an automobile accident, physical trauma, neurological conditions) may suffer from limited motor function due to paresis of their extremities. The limitation or disability of extremities such as hands can complicate performance of routine tasks and drastically impair the individual's quality of life.

Regaining partial or total function of the paretic hands and/or other appendages, and thereby regaining independence, can be a major goal for affected individuals (e.g., stroke survivors). In many instances, individuals with limited motor function will be prescribed physical therapy to exercise and regain motor function. Such physical therapy sessions typically take place at a medical or rehabilitation facility. The Inventors have recognized that in-person physical therapy sessions typically deliver around one tenth of the minimum therapy dosage expected to drive recovery. Furthermore, these sessions may be costly and challenging to get to, especially for elderly patients.

As an alternative or supplement, clinicians can prescribe rehabilitation exercises to be done at home. The Inventors have recognized that the effectiveness of at-home rehabilitation exercises can be limited by the patient's motivation, engagement, physical abilities, and/or skillset. Furthermore, the Inventors have appreciated that there are no standards for measuring recovery of appendages with motor deficits outside of the clinic, which can further limit the benefits of at-home rehabilitation. The Inventors have also recognized that the lack of feedback from at-home rehabilitation exercises may contribute to the patient's lack of motivation or engagement. In some cases, a patient can only receive feedback regarding their progress from a clinician during a clinical visit over the span of several weeks or months. Without tracking their own progress, the patient may lose confidence or patience with the rehabilitation exercises, which can reduce the efficacy of the therapy program. The Inventors have also recognized that there is a lack of tools available for clinicians to qualitatively track a patient's usage and progress of such rehabilitation systems, within either clinical or remote environments. Additionally, effective and optimal recovery can be difficult to achieve without proper progress tracking.

In view of the above, the Inventors have recognized the need for a rehabilitation system which can help improve motor functions by providing comfortable and personalized exercises which can be performed in home, remote, and/or clinical settings. Such a system may facilitate an individual performing higher doses of clinically appropriate rehabilitation exercises while receiving feedback on their progress metrics. The Inventors have also recognized the need for a rehabilitation system which can provide real-time feedback of the rehabilitation exercises to the user and/or clinician. Feedback may improve patient engagement with the exercises by tracking rehabilitation progress, and allow the rehabilitation to be adjusted at greater frequencies to optimize the rehabilitation therapy. Feedback can be given in real-time, immediately after a use, and/or on-demand at a later time through a user interface or other remotely connected interface. However, instances in which different benefits are offered by the systems and methods disclosed herein are also possible.

Based on the foregoing, the Inventors have recognized the benefits associated with a rehabilitation system including a wearable robotic system which may facilitate rehabilitation exercises and assess the quality of said exercises. The wearable robotic system may include one or more actuators which can actively manipulate the individual's appendage (e.g., hand) as well as one or more sensors to detect one or more parameters associated with the movement of the individual's appendage. The system may then analyze or process data from the one or more sensors to calculate clinical metrics of motor and/or sensory function and impairment (e.g., range of motion, spasticity, tone, rigidity, stiffness, proprioception impairment) of the appendage. The system may then communicate the processed data related to an assessment of the exercises and/or movements of the individual and/or to a clinician who may use such metrics to track the progress of the individual over time. The individual, clinician and/or, an integrated automated system may then choose to adjust the exercises to better fit the individual's needs and progress as elaborated on further below. The rehabilitation system may provide information related to the rehabilitation exercises to the individual and/or clinician in real-time, immediately after use, or later on demand of the individual/clinician. The ability to have constantly up to date feedback may facilitate more frequent adjustments to the exercises to optimize the individual's rehabilitation. In some cases, the real-time feedback may provide greater insight of the exercises to the individual and/or clinician and motivate the individual to continue the rehabilitation exercises in an engaging manner.

It should be appreciated that the rehabilitation systems described herein may be capable of providing feedback at any suitable timing. In some embodiments, rehabilitation systems may provide real-time feedback including, for example, but not limited to, biofeedback on the appendage position, force, torque, and/or resistance as well as feedbacks related to various parameters associated with the operation of the device and/or movement of a subject's appendage using a display as described herein. In some embodiments, rehabilitation systems may provide on-demand feedback from data stored within the system, which may include longitudinal aggregates (e.g., averages and distribution metrics) of various sensor measurements and assessments performed as well as feedbacks related to various parameters associated with the operation of the device and/or movement of a subject's appendage using a display as described herein. In some embodiments, a rehabilitation system may be capable of providing both real-time and on-demand feedback.

In some embodiments, a rehabilitation system may include a wearable robotic system, one or more controllers (e.g., one or more processors associated with non-transitory computer readable memory including processor executable instructions that when executed perform any of the methods disclosed herein), and a display (e.g., a display screen, speaker, or other type of visual and/or auditory display). The various electronic connections between the components may either be wired and/or wireless. A user (e.g., an individual with impaired motor function) may don the wearable robotic system(s) on one or more appendages for which physical therapy is desired. The wearable robotic system may include one or more actuators for inducing or aiding the user to move their hand, or other appendage, according to a clinically appropriate rehabilitation exercise. In some embodiments, the wearable robotic system may include one or more sensors for measuring one or more parameters associated with motion of the user's appendage during an exercise (e.g., displacement, position, orientation, force, torque, pressure etc.). The actuator(s), sensor(s), and/or other components of the rehabilitation system may communicate with one or more components of the system for either communication and/or control purposes (e.g., controllers, transmitters, etc.). The system may communicate information to the user with visual and/or auditory feedback via the display. In this way, the user may undergo a prescribed rehabilitation exercise by following instructions or suggestions communicated to the user via the display. In some embodiments, the user may also receive real-time analysis of their exercise via the display, followed up with an assessment of one or more performance metrics to provide feedback to the user. In some embodiments, the system may also be in communication with one or more external parties (e.g., a medical clinician) to provide results (either in real-time, through a network connection, and/or on-demand after the completion of the exercises, by storing and recalling results) of the rehabilitation exercises to the external party.

In some embodiments, a wearable robotic system may employ soft robotic components to comfortably conform to a user's appendage (e.g., hand) and allow the user to operate said hand in a natural manner. The wearable robotic system may include comfortable, textile, fabric-based components, straps, and/or other appropriate non-rigid (i.e., flexible) components that may conform to and/or fit around one or more portions of the appendage. For example, in some embodiments, the wearable robotic system may be a glove. Such a glove may be used to both manipulate the hand and sense movement of the hand. In some embodiments, the glove may include modules which may be adjusted to improve the fit of the glove. Of course, while a glove is primarily described in relation to the various embodiments described herein, it should be understood that the current disclosure is not limited to wearable robotic systems only in the form of gloves. For example, appropriate wearable robotic systems may include, but are not limited to, wearables configured for being worn on one or more portions of a hand (e.g., fingers, wrist, palm), elbow, shoulder, back, knee, hip, ankle, neck, waist, and/or any other appropriate portion of a user's body associated with one or more joints of an appendage where applying physical therapy and/or assessments to the appendage is desired. In some embodiments, the wearable robotic system may be used on one or more portions of an upper extremity (e.g., shoulder, elbow, wrist, hand). In some embodiments, the wearable robotic system may be used on one or more portions of a lower extremity (e.g., ankle, knee). It should be appreciated that the wearable robotic systems herein may facilitate rehabilitation of any suitable joint or combination of joints of any suitable appendage.

In some embodiments, the wearable robotic system may include one or more compliant actuated components which may be actuated pneumatically and/or electrically (e.g., inflatable bladders, electroactive materials, etc.) which may be operated to replicate and/or support the natural movement of one or more appendages. For example, the wearable robotic system may include one or more features to mimic (e.g., by flexing and extending) and/or support the natural movement of the human fingers and thumbs. In embodiments, the actuators are incorporated into flexible structures including one or more rigid segments which may be configured to facilitate movement of a joint when the actuators are deformed (e.g., expanded or contracted). For example, a glove or other system for use with a hand, may include one or more inflatable components located in between two or more rigid segments representative of a phalanx or phalanges where the actuators and the rigid segments may be integrated into an overall soft flexible structure. The expansion or contraction of the actuators may allow the wearable to “bend” akin to the bending of the joints of a finger. In some embodiments, the arrangement of rigid and soft components may allow the wearable to contract to a contracted configuration (e.g., form a fist by approximating the fingertips to the palm) or extend to an extended configuration (e.g., flatten the fingers with respect to the palm) the hand.

It should be appreciated that the actuators may support and mimic/replicate the natural movement of any suitable appendage (e.g., a hand (e.g., fingers, wrist, palm), elbow, shoulder, back, knee, hip, ankle, neck, waist, etc.). Accordingly, the actuators may be configured to move or deform akin to the appendage on which they are worn. For example, the actuators may be configured to axially extend or contract, undergo torsional and/or rotational strain, combinations thereof, and/or any other movement type. In some embodiments, the shape, size, and arrangement of the actuators may be suited for a particular appendage. For example, if the rehabilitation system is used to improve motor function in a knee, the wearable robotic system may be in the form of a band, which may wrap around at least a portion of the knee. In yet another example, the wearable robotic system is in the form of a wrap, used to rehabilitate the shoulder. In yet another example, the rehabilitation system is used to improve motor function in an elbow, the wearable robotic system being in the form of a band and/or wrap around the elbow. The wearable robotic system may be used for any suitable appendage or extremity, and/or combinations thereof. It should be appreciated that the present disclosure is not limited by the shape, arrangement, or type of wearable robotic system.

As noted above, in some embodiments, a wearable robotic system may be a flexible actuated system including one or more compliant actuators (e.g., pneumatics and electronic actuators). These actuators may be controlled by one or more associated processors which may operate the compliant actuator in accordance with a clinically appropriate rehabilitation exercise. In some embodiments of a glove, the compliant actuators may extend along the length of more than one phalanx, and/or may be arranged to anisotropically extend/contract, such that the finger may bend or deflect inwards towards the palm when inflated. Further details of the design and operation of various embodiments of a wearable rehabilitation system, including specifically a glove, may be found in U.S. Pat. No. 10,184,500, entitled “Multi-Segment Reinforced Actuators and Applications,” and PCT Patent Publication No. 2017/120314, entitled “Fabric-Based Soft Actuators,” which are both hereby incorporated by reference in their entirety.

In some embodiments, a wearable robotic system may include one or more sensors for measuring a user's appendage (e.g., hand) movement during an exercise. The one or more sensors may include one or more movement sensors, which may measure the extension/contraction of the glove. In some embodiments, the movement sensors may be located along one finger (e.g., an index finger), measuring the angular displacement of said finger, whereas in other embodiments, more than one finger of the glove may include a movement sensor. In some embodiments, the movement sensor may be positioned along at least a portion of a finger. In some embodiments, the movement sensor may be integrated into the actuator(s), as part of a fabrication process and/or may be inserted/embedded afterward. The movement sensor may be compliant and accordingly, conform along the finger in order to sense its minute deflections. In some embodiments, the movement sensor may be multi-segmented, measuring angular displacement between various phalanges of a finger. It should be appreciated that the rehabilitation systems of the present disclosure are not limited by the structure, arrangement, or fabrication of the one or more sensors. In some embodiments, movement sensing may be performed using computer vision, including, but not limited to, one or more cameras, infrared cameras, radars, lidars, combinations thereof, and/or any other appropriate type of sensor.

In some embodiments, the movement sensor may be a capacitive sensor. The sensor may include a pair of capacitors overlapping the desired bendable portion of a finger. Upon bending of the finger, one of the capacitors will experience a compressive strain while the other experiences a tensile strain. A differential capacitance measured between the two capacitors may provide a relatively noise-free output signal corresponding to the deflection of the finger. In some embodiments, the movement sensor in the glove may be connected (via a wired or wireless connection) to one or more components which may assess data from the movement sensor. Accordingly, the output signal of the movement sensor may be converted into a digital signal corresponding to the angle displacement (e.g., bend angle) of the finger and/or hand donning the glove. It should be appreciated that signals from more than one movement sensor may be used to actuate or sense movement within more than one finger. In some embodiments, a combination of movement sensors positioned on different fingers may provide insight on the motor function of each finger.

It should be appreciated that in some embodiments, a rehabilitation system may include one or more movement sensors. The sensors may be capacitive sensor(s), resistive sensor(s), inertial measurement unit sensor(s), hall effect sensor(s), optical sensor(s), combinations thereof, and/or any other suitable sensors. In some embodiments, a rehabilitation system may employ multiple sensors of the same type positioned at various locations on the wearable robotic system. For example, a rehabilitation system may include at least one inertial measurement sensor on a finger of a wearable robotic system and another inertial measurement sensor on the hand to monitor relative movement between the two sensors. In some embodiments, a rehabilitation system may employ more than one type of sensor to measure various parameters related to the appendage movement, including, but not limited to appendage bending, curvature, rotation, torsion, displacement, strain, pressure, combinations thereof, and/or any other suitable parameter. Of course, the rehabilitation system is not limited by the type or operation of the movement sensor, as the present disclosure is not so limited.

In some embodiments, a rehabilitation system may include one or more housings which may contain one or more non-transitory computer readable memories (e.g., random access memory, flash memory, hard drive) which may store real-time data incoming from the movement sensor. The data may then be transferred to one or more processors (which may, in some embodiments, also be stored in the housing) which may analyze or otherwise process said data, and pass on the results to one or more transmitters, which may relay said data to the display. In this way, the user (and/or a suitable clinician, which may have access to the rehabilitation system via a wired or wireless connection) may receive real-time updates of the rehabilitation session. The non-transitory computer readable memory may also store said data to allow the processor(s) to measure and compare progress of the user's motor skills over time (e.g., in between multiple sessions). The processor may also be in communication with one or more controllers configured to adjust the actuation of the glove based on the user's movement or expected movement, as will be described in greater detail below. It should be appreciated that any suitable electronic components known in the art may be employed to ensure proper signal communication, processing, and storing throughout the rehabilitation system, as the present disclosure is not so limited. In some embodiments, one or more data and/or analytical processes of the rehabilitation system may take place in the cloud or on a remote server. Accordingly, the one or more housings and associated components may be in wireless communication with a network which may securely store, process, transmit, control, and/or undergo any other suitable function of the system.

In operation, a user may follow a set of clinically relevant rehabilitation exercises as part of a routine with a rehabilitation system. The duration, intensity, or type of exercises may be modified by the user or a clinician to best suit the user's needs. In some embodiments, the exercises may include stretching, assisted movement, functional task training, and/or other exercises. Stretching may involve the actuation of the glove to gently extend or contract the hands to prepare the user for the exercises. In some embodiments, a stretching exercise may stretch out the flexor muscles of the arm in preparation for the exercises. In some embodiments, a stretching exercise may be performed at the end of a rehabilitation session to relax the hand. Assisted movement may involve the user's engagement in one or more games (communicated to the user via a display), facilitated by gentle assistance of the actuatable glove. As will be described in greater detail below, the rehabilitation system may include one or more intention detectors for evaluating whether or not the user is attempting to complete a movement (e.g., a game). In this way, the glove may assist the user complete a desired movement, rather than undergo the movement independently without input from the user. Functional task training may involve the user's manipulation of a physical object (e.g., a foam block or ball) with gentle assistance from the glove and guidance from the display. It should be appreciated that a rehabilitation session may include one or more of the aforementioned features, as well as other activities or exercises, as the present disclosure is not so limited.

While the rehabilitation system is described in reference to individuals who have experienced stroke and need rehabilitation of the hand, the disclosed rehabilitation systems are not limited to any particular type of medical condition or appendage. For example, the disclosed methods and systems may be employed to facilitate restoration of motor function for individuals who have muscle control conditions such as multiple sclerosis (MS), arthritis, amyotrophic lateral sclerosis (ALS), hypokalemic periodic paralysis, cerebral palsy, and other neurological conditions and diseases. The rehabilitation methods and systems may also be employed by individuals who have undergone direct trauma to their appendages, or who may have experienced brain injury (e.g., caused by a work incident, explosions, field-work) leading to extremity paresis. Thus, the disclosed methods and systems may be used for any appropriate medical condition and/or disease for which rehabilitation may be desirable, including, but not limited to, orthopedic conditions, post-surgical rehabilitation, and/or post-burn rehabilitation. Additionally, the methods and systems may be used for any appropriate appendage including rehabilitation of various joints including the joints of the hand, an elbow, a shoulder, a back, a knee, a hip, an ankle, the joints of the foot, and/or any other appropriate joint of an appendage of a subject. Accordingly, any suitable wearable robotic system form factor may be employed to accommodate one or more joints/appendages. In some embodiments, the wearable robotic systems may be in the form of cuffs, belts, sleeves, bands, gloves, shoes, elbow pads, knee pads, and/or any other suitable form factor.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

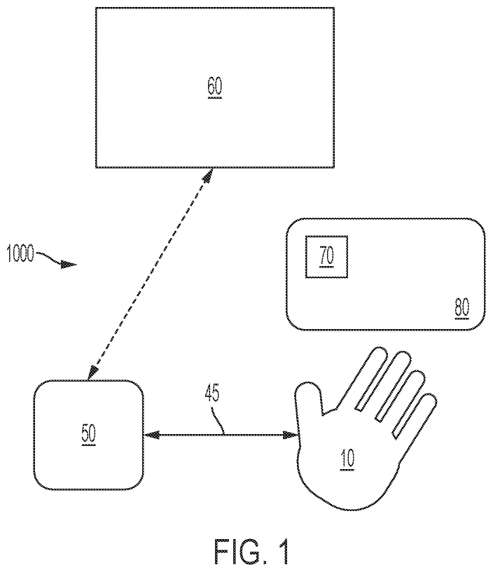

FIG. 1 shows a schematic of a rehabilitation system 1000 according to some embodiments. The system 1000 may include a wearable robotic system (e.g., glove) 10 which may be worn by a user in order to engage with the system 1000. The glove 10 may be in communication with a housing 50 with a wired or wireless connection 45. In some embodiments, the glove 10 may include active, compliant, actuatable components, which may be controlled through one or more components (e.g., controllers, pneumatic systems) within the housing 50. The connection 45 may also facilitate data transfer from one or more components (e.g., sensors) of the glove 10 to the housing 50. It should be appreciated that although a single line is shown to represent the connection 45, the connection may comprise one or more connections (e.g., electrical wires, pneumatic tubing), as the present disclosure is not so limited. It should be appreciated that although a single glove is shown in FIG. 1, the system may be used with more than one glove or other wearable robotic systems, as the present disclosure is not so limited.

In some embodiments, the system 1000 may include a display 60 (which may, in some embodiments, be a display screen) in communication with the housing 50. The display 60 may provide visual and/or audible feedback to the user regarding the rehabilitation exercises and progress. For example, the display 60 may present instructions on how to proceed with a game or functional activity. In another example, the display 60 may present graphics depicting progress metrics of one or more rehabilitation sessions. In some embodiments, the display 60 may be an interactive (e.g., through touch or audible input) display, whereas in other embodiments, the display 60 may not be interactive. In some embodiments, the display 60 may be a separate component in communication (wired or wirelessly) with the housing 50, whereas in other embodiments, the display may be directly integrated into the housing.

It should be appreciated that in some embodiments, the system may be in communication with a mobile phone, tablet, or computer, such that a screen of said external device may be used as the display of the system. Accordingly, the exercises may be followed using software or a mobile application which may be in communication with the system. In some embodiments, the system may be in communication with a display device which may be at a remote location. For example, the system may be used in a telehealth/telerehab manner, such that the system (which may, for example, be used by the user at home) may be in communication with a display device at a clinic, where a medical professional may observe the rehabilitation exercises and resulting assessments in real-time. In some embodiments, the display may enable video or audio communication between the user and the clinician in real time. In this way, the system may provide real-time feedback of the user's progress, and the clinician may provide real-time feedback to the user via another display located with the user or any other means. In some embodiments, the system may be simultaneously in communication with a display at the user's location and one or more displays at a remote location. In this way, all parties (e.g., user and clinician(s)) may be provided with real-time progression of the rehabilitation session. In some embodiments, the system may store data from one or more rehabilitation sessions to provide to a clinician at a later time, such that the clinician may review the session and provide feedback to the user after the completion of the session.

As described in further detail above, the housing 50 may include one or more non-transitory computer readable memory, processing, communication and/or controlling components for operating the system 1000. In some embodiments, the components within the housing 50 may capture and process real-time feedback of the user's operation of the glove 10 and send said feedback to the display 60 for the user's or any other party's review. For example, the housing 50 may retrieve data from one or more sensors of the glove 10 to evaluate the movement of the user's hand (and/or any other appendage(s) on which a wearable robotic system is worn), and then process that data to further engage or disengage the glove 10 and/or communicate said data on the display 60. It should be appreciated that any suitable arrangement and selection of electronics and communication components may be used to operate the rehabilitation system, as the present disclosure is not so limited.

In some embodiments, a rehabilitation system 1000 may also include one or more manipulatable components (e.g., a foam block) 70 and a training mat 80. A rehabilitation exercise may require the user to manipulate the foam block 70 around the mat 80 to assess one or more motor functions throughout the exercise. In some embodiments, the mat 80 may serve as a guide for where to move the foam block. The mat may include one or more sensors (e.g., tactile sensors, cameras, etc.), such that it may detect movement, contact, forces, and/or any other engagement of the user with the mat. Although not shown in FIG. 1, the system may also include a wrist support pillow (to allow a user to comfortably rest their wrist during a session), an instruction manual (to guide the user on the operation of the system), a carrying bag (for storage purposes and/or to allow the user to transport the system as needed), and/or any other suitable component or accessory. For example, the system may include one or more hardware components to facilitate video calling, such as headphones, speakerphones, and/or a camera.

In some embodiments, the system may be powered via a portable battery, and/or may use a separate power source. In some embodiments, the system may be portable, such that it may be used in any suitable environment to allow a user to perform rehabilitation exercises at any time/place. The system may include one or more features to allow the system (including all associated hardware) to be wearable. In some embodiments, the system may be in the form of and/or configured to be placed inside a portable/wearable bag such as a purse, a backpack, a fanny pack, and/or any other suitable structure. In some embodiments, the system may be used in a telehealth/telerehab format, wherein a clinician may have remote access to real-time data and assessments of a rehabilitation session. In some embodiments, the system may be used independently by a user, providing the user with real-time data and assessments of the session. The system may then pass on said results to a clinician for review and adjustment at a later date. In some embodiments, the system may be used when the user and the clinician are in the same location. For example, the glove may automate many of the manual processes that a clinician may typically perform, which may optimize the rehabilitation session and focus the clinician's attention on other aspects of the session.

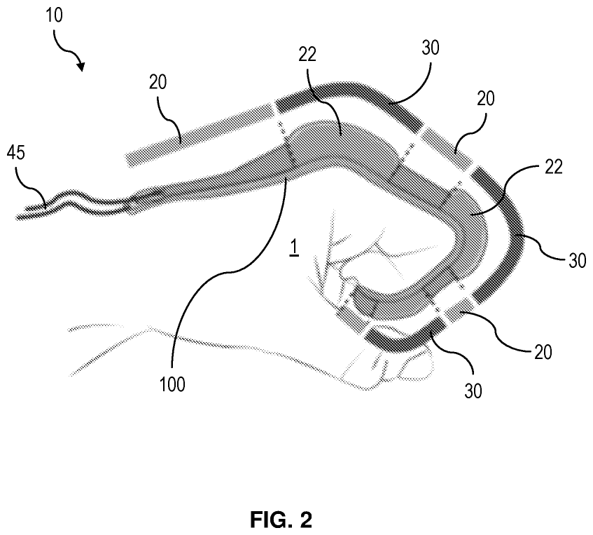

FIG. 2 shows a partial schematic of a hand 1 donning a glove 10. The glove 10 may include flexible, textile-based surfaces 100 which may directly contact the hand 1, ensuring comfortable and conformal contact. In some embodiments, the glove 10 may include one or more stiff segments 20 and bendable segments 30. The stiff segments 20 may mimic the rigid phalanx regions of the fingers, whereas the bendable segments 30 may mimic the bendable joints, allowing the hand 1 to extend or contract. It should be appreciated that the stiff segments are only described to be stiff in relation to the softer, more compliant bending segments. Accordingly, the stiff segments may still be sufficiently compliant to allow comfortable operation of the glove. In some embodiments, the bendable segments 30 may be achieved with one or more inflatable bladders 22. These inflatable bladders 22 may be controlled via pneumatics housed in a housing of the rehabilitation system. Accordingly, the glove 10 may be in communication with the housing via one or more conduit-like connections 45. In some embodiments, fluid (e.g., air) may pass through the connections 45 to inflate or deflate the bladders 22 to extend or contract the hand 1. It should be appreciated that FIG. 1 shows a hand 1 in a state of contraction, wherein the fingers are approximated to the palm due to the inflation of the bladders 22.

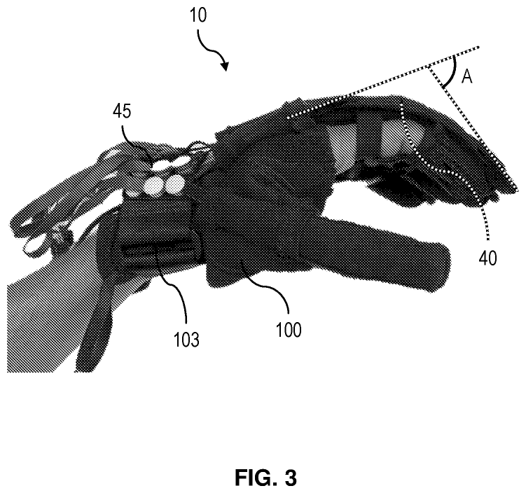

FIG. 3 shows a glove 10 according to some embodiments. The glove 10 may include textile-based surfaces 100 which may be used to form the general structure of the glove, and to conform around one or more portions of the hand. The glove 10 may also include one or more adjustments 103 to allow a user to adjust the glove 10 to comfortably fit their hand. As discussed previously, the glove 10 may include one or more connections 45 to communicate with a housing or other component of a rehabilitation system. The connections 45 may include tubular connections (e.g., for pneumatic operation of the glove), electrical connections (e.g., for signal and/or power transport between the glove and the housing), and/or any other suitable connection.

In some embodiments, the glove may include one or more sensors configured to measure physical parameter(s) of the glove and communicate said parameter(s) to the housing for assessment of the rehabilitation session. In some embodiments, the glove 10 may include one or more movement sensors 40. FIG. 2 shows a movement sensor 40 positioned along at least a portion of the user's index finger. The movement sensor 40 may bend along with the user's finger, due to intentional physical movement of the finger by the user and/or due to actuation of the glove. Accordingly, in some embodiments, a movement sensor may be a bend sensor, such that it relay a bending angle A measured between various segments of the finger to a controller (e.g., one or more processors and associated non-transitory computer readable memory), which in the depicted embodiment may be located in the housing. In this way, the housing may have real-time data of the extension or contraction of the hand donning the glove 10. It should be appreciated that a glove may include more than one movement sensor, positioned on multiple fingers.

In some embodiments, a rehabilitation session may include one or more calibration assessments, stretching, activities, and/or other stages suited to a user's needs. The sessions may follow a clinically relevant format, and may be designed with the guidance of a certified clinician. The sessions may take place during any suitable duration (e.g., at least 10 min, 15 min, 20 min, 30 min, 45 min, 60 min) which may be recommended by the clinician and may be comfortable for the user.

In some embodiments, a rehabilitation session may begin with a calibration assessment. The calibration assessment may be performed to evaluate the active range of motion of the user's appendage prior to the rehabilitation session. The user may be prompted to extend or contract their appendage (e.g., hand) to their greatest comfortable capacity. In this process, the wearable robotic system (e.g., glove) may be static, such that it does not apply a significant extension or contraction force on the hand. Accordingly, movement sensors associated with the glove may measure the user's own capacity to extend or contract their hand. These measurements (e.g., bend angle of the hand/finger) may be stored for future reference. For example, the measurements may be stored and later compared with similar assessments performed at the end of the rehabilitation session to monitor the effects and progress of said session. In some embodiments, the calibration assessment may evaluate the grip strength of the user's hand. In some embodiments, this calibration assessment of the user's hand may replicate a clinician's manual measurement of the hand's bend angles using a goniometer. The rehabilitation system herein provides a simple, automated process to replicate such measurements in an accurate and reliable manner.

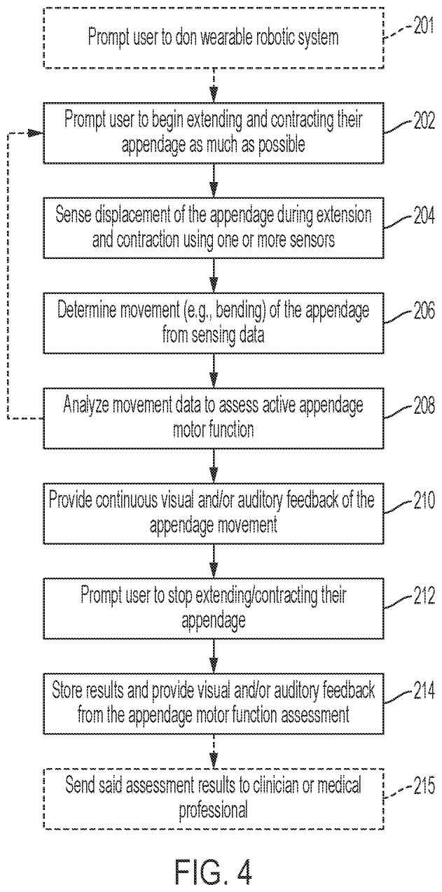

FIG. 4 shows, according to some embodiments, a flow chart for a calibration assessment process using the rehabilitation systems described herein. In block 201, a user is prompted to don one or more wearable robotic systems (e.g., a glove), if not already worn. In block 202, the user is prompted to begin maximally (but comfortably) extending or contracting the appendage on which the robotic system is worn (e.g., a hand). It should be appreciated that in this block, the glove is not actuated, such that it may not apply a significant force to the user's hand. In some embodiments, this prompting may occur with the display, with auditory, tactile, and/or visual feedback. The glove may include one or more sensors (e.g., movement sensors) configured to sense displacement of the appendage during extension and contraction of the hand, as shown in block 204. The system may then process the sensor data to determine movement (e.g., bending) of the appendage, as shown in block 206, and subsequently analyze said movement data to assess the active motor function of the appendage, as shown in block 208. In some embodiments, this processing may occur with the aid of one or more processors and/or non-transitory computer-readable memory components, which may be located in a housing in electrical communication with the glove. In some embodiments, the process of blocks 202-208 may be repeated over multiple cycles, such that the processor(s) may calculate statistics of the appendage's active motor function.

As the user is following the instructions of this assessment, the display may also provide up to date feedback (e.g., real-time and/or on-demand feedback) regarding the appendage's movement as measured by the glove and processed by the system, as depicted in block 210. In some embodiments, this real-time feedback may be an animation on the display representing the hand's movement and user-friendly information regarding the progression of the exercise. As described previously, this real-time feedback may also be relayed to a clinician in a telehealth/telerehab format. In block 212, the system may prompt the user to stop the extension/contraction cycles after having gone through a clinically relevant number of cycles. In block 214, the system may then store the assessment results in one or more non-transitory computer-readable memory components and provide said results in a user-friendly format (e.g., with visual and/or audio signals) to the user and/or clinician via a display. For example, a graphical interface with a user-friendly metric and/or animated visuals may be shown via the display to communicate the results of the assessment to the user and/or clinician. The system may use said results at a later point in the session to track the progress of the user's hand in response to the exercises. In some embodiments, the user may undergo a rehabilitation exercise independently (e.g., without the live/real-time feedback and/or monitoring of a clinician). As such, the system may also send such results to the clinician separately for analysis, as shown in block 215.

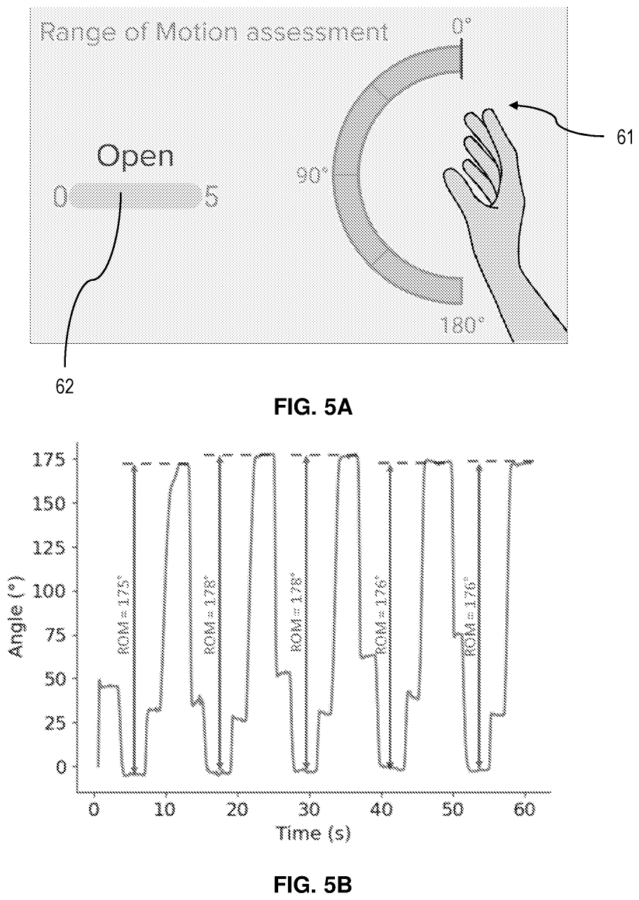

FIG. 5A shows an example of a graphical interface on a display which may be shown to the user during a calibration assessment (e.g., block 210 in FIG. 4). The display may include an animation 61 moving in real-time according to the movement of the user's appendage (e.g., hand), collected by the one or more sensors of the wearable robotic system (e.g., block 204, 206 in FIG. 4). This visual depiction may enhance the user's experience and better inform the user about their progress. In some embodiments, a display may also include one or more instructions 62, which may include information regarding what to do with the gloved hand (e.g., “open”) and how many cycles or how much time remains in the assessment. It should be appreciated that in some embodiments, the clinician and the user may be presented with the same user-friendly graphical interface, whereas in other embodiments, the clinician may receive more technical information regarding the progress of the user.

As described earlier, the calibration assessment may be performed to evaluate the user's active range of motion prior to the rehabilitation exercises, with little or no engagement of the glove's actuators. Accordingly, the movement sensor(s) of the glove may measure the user's own range of motion. FIG. 5B shows an exemplary plot of bending angle (derived from the movement sensor data) as a function of time when a user has been instructed to contract and extend their hand a preset number of clinically relevant cycles. The total range of motion (ROM) may be calculated by measuring the total range of the bending angle through one cycle. In some embodiments, the range of motion assessment metrics may include the statistical mean (or any other processing) of the various bending cycles.

In some embodiments, a rehabilitation session may include one or more stretching assessments for measuring a user's passive range of motion. In these assessments, the user is prompted to relax an appendage (e.g., a hand) and allow the wearable robotic system (e.g., glove) to contract and extend their hand by controlling one or more actuators within the wearable robotic system. In some embodiments, the glove may contract/extend the hand by modulating inflatable bladder pressures within the glove. In some embodiments, the stretching assessment may include extension/contraction cycles of the hand with varied (e.g., gently increasing) forces. One or more movement sensors may then sense the displacement of the hand associated with the active actuation of the glove. The system may then capture, store, and/or process this data from the sensors and later compare or transmit assessment results to the user and/or clinician for review. In some embodiments, the stretching assessment, which may actively engage the flexor muscles, may prepare the user's hand for the remaining exercises of the session. Accordingly, the user may experience greater hand flexibility as a result of such stretching.

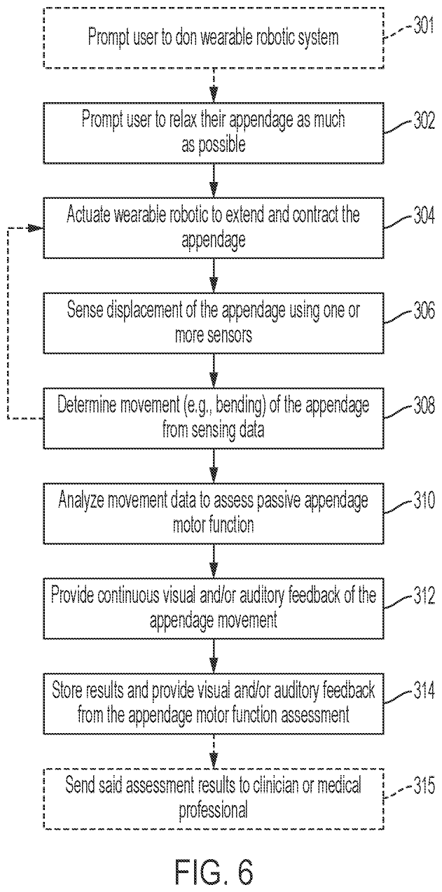

FIG. 6 shows, according to some embodiments, a flow chart for a stretching process using the rehabilitation systems described herein. If the stretching process is the first stage of a rehabilitation session, a user may be prompted to put on a wearable robotic system (e.g., a glove), as shown in block 301. Otherwise, the process may begin by first prompting the user to relax the appendage on which the wearable robotic system is worn (e.g., their hand), as shown in block 302. As described previously, the prompt may be visual, audible, tactile (e.g., vibration), and/or any combination thereof. The wearable robotic system may then be actuated to cyclically extend and contract the appendage (and/or follow any other movement natural to the appendage), as shown in block 304. In some embodiments, this actuation may take place due to modulation of pressure within one or more bladders of the glove to extend and contract the appendage. Accordingly, block 304 may include communication between the glove and one or more controllers, which may control inflation/deflation of said bladders through one or more pneumatic connections between a housing and the glove.

In some embodiments, the glove may include one or more sensors configured to sense one or more parameters of the appendage's motion (e.g., displacement). The one or more sensors may sense the displacement of the appendage due to contraction/extension of the glove, as shown in block 306. As described previously, the rehabilitation system may use said sensed data to determine movement (e.g., bending, torque, force) of the appendage, as shown in block 308. In block 310, said data may be analyzed/processed to assess the appendage's passive motor function, as the user was previously instructed to relax their appendage (see block 302).In some embodiments, the processes between block 304-308 may be repeated over a clinically relevant number of cycles to allow the system to calculate statistics for the assessment results.

In some embodiments, the user may be presented with a graphical interface with real-time, continuous visual and/or auditory feedback to ensure they maintain a relaxed state in their hand, as shown in block 312. For example, the user may be shown a relaxing animation while the glove is gently stretching and contracting the hand. In block 314, the system may store results from the assessment (e.g., how far the glove was able to contract and/or extend the hand) and provide said results in a graphical interface to the user and/or clinician on one or more displays. In some embodiments, the user may undergo a rehabilitation exercise independently. As such, the system may also optionally send such results to the clinician separately for analysis, as shown in block 315.

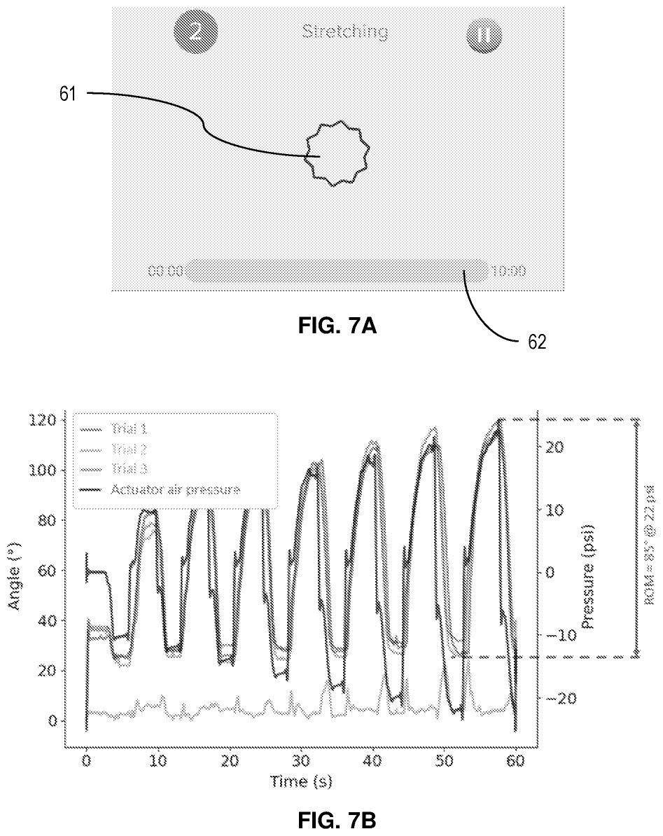

FIG. 7A shows a graphical interface on a display during a stretching exercise according to some embodiments. The interface may include a relaxing animation 61, which may relax the user and allow the glove to measure the desired passive range of motion more accurately. In some embodiments, the interface may include one or more instructional graphics 62 (e.g., progress bars) which may indicate the duration and remaining time or cycles of the particular segment. It should be appreciated that the user interface may include any suitable feature to communicate with a user and/or clinician, as the present disclosure is not limited by the visual presentation of the graphical interfaces described herein. For example, the graphical interface may include a video portion which may provide a live view of a clinician and/or a live view of the user for the clinician. Accordingly, the system may also include one or more cameras, headphones, and/or any other suitable hardware/software to enable a telehealth/telerehab session.

As described earlier, the stretching process may be performed to evaluate the user's passive range of motion by relaxing the hand and allowing the glove to independently extend and contract the hand. FIG. 7B shows an exemplary plot of bending angle (derived from the movement sensor data) as a function of time when a user has been instructed to relax their hand while the glove contracts and extends their hand a preset number of clinically relevant cycles. The total range of motion (ROM) may be calculated by measuring the total range of the bending angle through one cycle. In some embodiments, the glove may apply gently increasing forces to the hand. For example, the stretching process may include seven stretching cycles, with each cycle having a greater actuator air pressure than the last. In this way, the hand may be gently stretched over multiple cycles, by increasing the magnitude of the stretching force in each cycle. In some embodiments, the maximum ROM (e.g., at 22 psi, as shown in the right hand y-axis of FIG. 7B) may be the metric used to evaluate the stretching process. Of course, alternative modes of evaluating movement sensor data are also contemplated. In some embodiments, the interaction between the wearable robotic system and the appendage may be used to assess the appendage's function and/or impairment. In some embodiments, reaction forces between the wearable robotic system and appendage may be measured (e.g., with a pressure sensor and/or force sensitive resistor) when the wearable is actuated (as shown in FIG. 7B) to assess properties of the appendage, including, for example, spasticity, tone, and/or muscle rigidity among others. In some embodiments, the total ROM and/or other metrics derived from data of the movement sensor(s) may also be used for these measurements.

In some embodiments, a rehabilitation session may include one or more contraction and extension force assessments. In these force assessments, a wearable robotic system (e.g., a glove) may apply a high resistance force in either the contraction or extension direction. The user may then be prompted to apply as much force as possible in an opposing direction. For example, if the glove is forcing the appendage on which it is worn (e.g., a hand) into an extended configuration, the user may be prompted to contract their hand as much as possible. One or more movement sensors may then measure the bending of the glove associated with the exercise. The system may then capture, store, and/or process this data from the sensors and compare or transmit assessment results to the user and/or clinician for review. In some embodiments, the movement sensor may collect total angular displacement data from the appendage, which may be converted to a force value generated by the appendage. In some embodiments, the conversion from angular displacement to force may be conducted by approximating the finger as a beam.

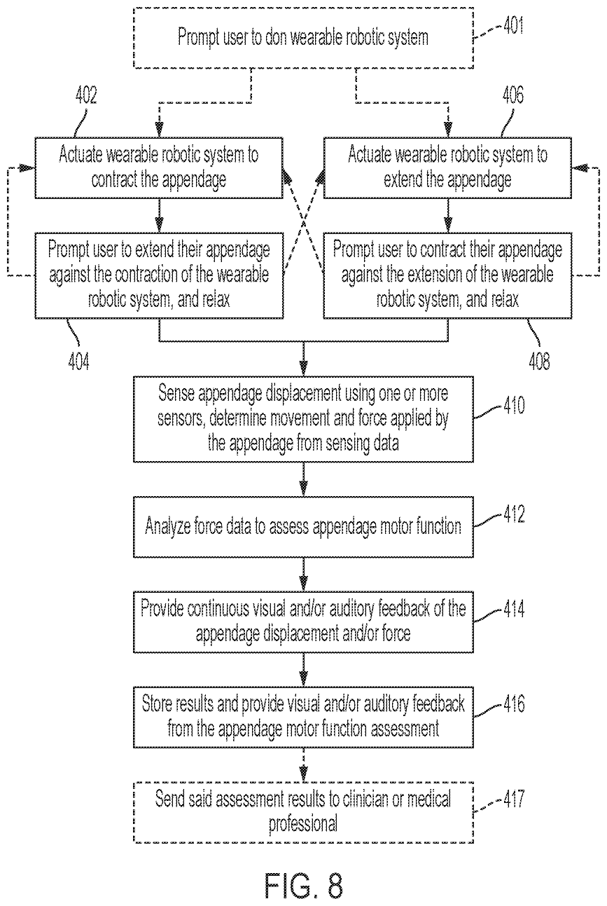

FIG. 8 shows, according to some embodiments, a flow chart for performing a force assessment using the rehabilitation systems described herein. If the assessment is taking place at the beginning of a rehabilitation session, the user may be prompted to don the wearable robotic system (e.g., a glove), as shown in block 401. Otherwise, the assessment may begin by actuating the glove by modulating pressure in one or more bladders to contract the appendage (e.g., hand), as shown in block 402. The system may then prompt the user to extend their appendage (e.g., gloved hand) as much as possible against a high resistance contraction force of the glove, applied by the inflatable bladders, as shown in block 404. In some embodiments, the system may also actuate the glove to extend the appendage, as shown in block 406, and prompt the user to contract the appendage against the force of the glove, as shown in block 408. In some embodiments, prompts to extend/contract the appendage may be followed by prompts to relax said appendage after a clinically relevant duration of time (e.g., one minute) and/or a prescribed number of repetitions has passed, as shown in blocks 404 and 408. It should be appreciated that the system may cycle through a clinically relevant number of the extension/contraction cycles. In some embodiments, the cycles may comprise switching between extension and contraction. In some embodiments, the cycles may comprise repeated extension cycles before switching to repeated contraction cycles. It should be appreciated that any suitable order of events (extension before contraction or contraction before extension) may be employed, as the present disclosure is not limited by the order or arrangement of steps in a force assessment.

As discussed previously, the glove may collect appendage displacement (or any other suitable parameter) data in order to determine movement and/or force of the appendage, as shown in block 410. In some embodiments, the force applied by the appendage may be determined using sensed angular displacement data of one or more movement sensors located on the glove. The data may then be further processed/analyzed to assess the appendage's motor capabilities (e.g., how much force the appendage can apply in opposition to the glove's actuation), as shown in block 412. In block 414, the user may be provided with real-time, continuous visual and/or auditory feedback regarding their progress via a display. Once a clinically appropriate number of cycles has passed, the system may store, process, and communicate the assessment result via the display, as shown in block 416. As discussed previously, the system may also send such results to an external party (e.g., a clinician), as shown in block 417. It should be appreciated that the order of extension and contraction may be reversed or alternatively arranged, as the present disclosure is not so limited.

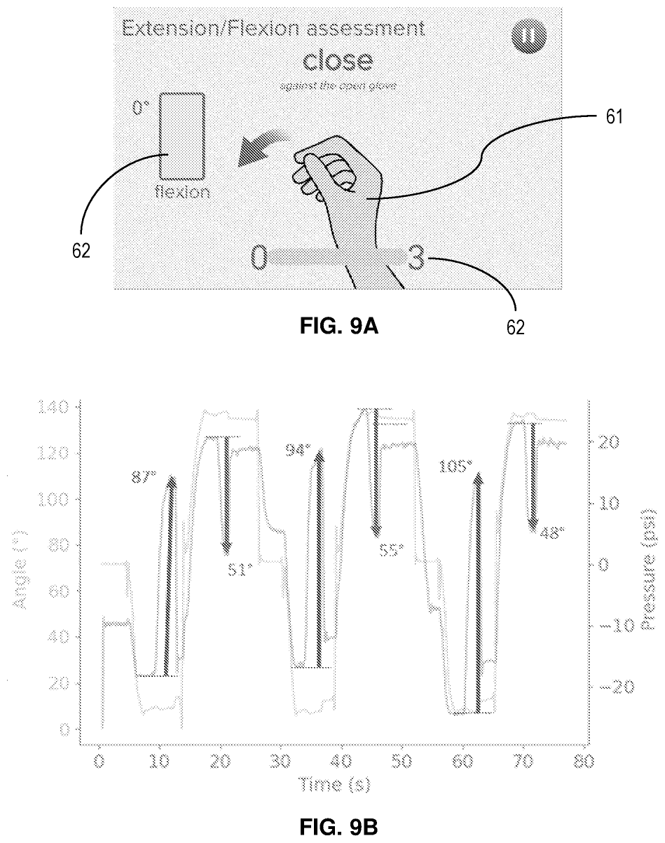

FIG. 9A shows a graphical interface on a display during a force assessment, according to some embodiments. The graphical interface may include one or more animations 61 providing visual instructions to guide a user through an assessment. The graphical interface may also include one or more instructions 62, which may include information regarding what to do with the gloved hand (e.g., “open”) and how many cycles or how much time remains in the assessment. As noted previously, it should be appreciated that the present disclosure is not limited by the design, arrangement, or features of any such graphical interface.

In some embodiments, a force assessment may be performed by asking a user to maintain appendage static while the wearable robotic system applies force to move the appendage. The user's reaction force may then be measured as the required system force required to move the appendage over a threshold. In some embodiments, the force assessment may be functionally similar to a conventional assessment using a dynamometer (e.g., Biodex), using instead, a wearable robotic system.

As described earlier, the force assessment may be performed to evaluate the user's ability to push back against a high resistance force applied by the glove. FIG. 9B shows an exemplary plot of bending angle (derived from the movement sensor data) as a function of time when a user has been instructed to contract and extend their hand against the glove's resistance force a preset number of clinically relevant cycles. The total range of motion (ROM) may be calculated by measuring the total range of the bending angle through one cycle. In some embodiments, the range of motion assessment metrics may include the statistical mean (or any other processing) of the various bending cycles.

In some embodiments, a rehabilitation session may include spasticity assessment to measure the hand's spasticity in resistance against different speeds of passive extension. In some embodiments, passive extension may comprise the wearable robotic system extension of the appendage while the appendage is relaxed (e.g., the user is not actively extending or contracting said appendage). The wearable robotic system may be actuated via any suitable mechanism, such as bladder inflation as previously discussed. These assessments may mimic the clinically-relevant Modified Ashworth Scale, where the clinician may stretch the user's hand to evaluate its resistance to said movement following a scale from 0 (normal) to 4 (severe spasticity). The rehabilitation systems described herein may employ varied speeds of stretching movements of the gloved hand to measure the spasticity level by calculating the difference between expected and actual time for movement completion.

In some embodiments, a rehabilitation session may include force response assessments to evaluate the time it takes for the user to release their appendage (e.g., hand) after contraction. In some embodiments, the force response assessment may be known as a grip time to release assessment. The system may prompt the user to relax their hand while the wearable robotic system (e.g., glove) is actuated to extend the hand to a pre-established configuration. The user may then be asked to contract the hand (e.g., form a fist) against the extension force of the glove. Next, the user may be asked to relax again, while the glove maintains its actuated state and continues actively extending the appendage. This way, the system may measure the grip time to release response of the gloved hand by measuring the time from the second relaxation prompt to when the gloved hand seems to reach a relaxed state. The user may strive to reduce this response time during their rehabilitation process.

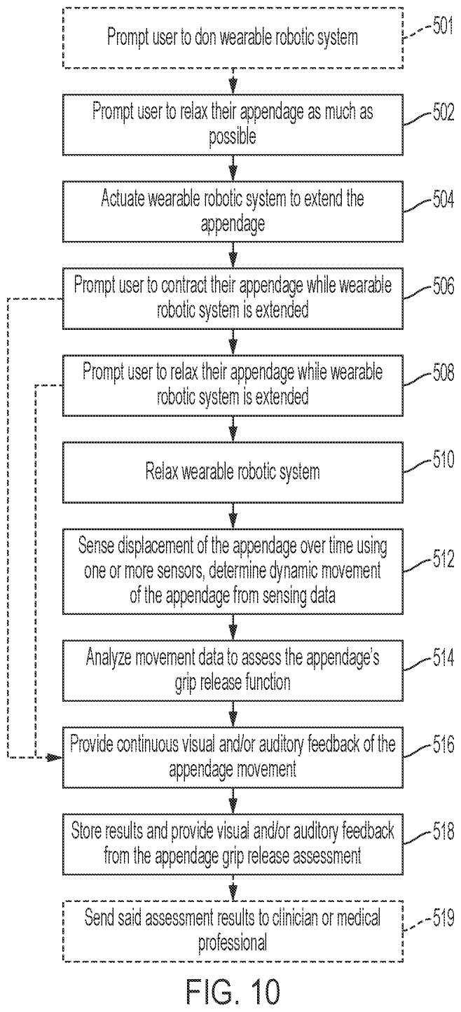

FIG. 10 shows, according to some embodiments, a flow chart for a force response assessment. If the force response assessment is the first stage of a rehabilitation session, a user may be prompted to put on the wearable robotic system (e.g., glove), as shown in block 501. Otherwise, the assessment may begin by first prompting the user to relax their appendage (e.g., hand), as shown in block 502. As described previously, the prompt may be visual, audible, tactile (e.g., vibration), and/or any combination thereof. The wearable robotic system may then be actuated (e.g., via inflatable bladders and/or any other suitable mechanisms) to extend the appendage, as shown in block 504. The rehabilitation system may maintain the extended configuration of the glove and subsequently prompt the user to contract their hand against the extension of the glove, as shown in block 506. Next, the system may prompt the user to relax their appendage, as shown in block 508. As described previously, this relaxation may occur while the glove is in the extended configuration. The system may then relax the glove by ceasing actuation, as shown in block 510. In order to assess the force response, the rehabilitation system may use time-displacement data collected by the one or more sensors (e.g., movement sensors) of the glove to determine the movement of the appendage, as shown in block 512. For example, the system may calculate the time it takes for the appendage to relax after the second relaxation prompt (block 508), while the glove is in the extended configuration. In this way, the appendage's grip release function may be assessed, as shown in block 514.

In some embodiments, as shown in block 516, the user may be presented with a graphical interface with real-time, continuous visual and/or auditory feedback regarding their progress. It should be appreciated that the real-time feedback may be provided to the user at any suitable point during any assessment. For example, the system may provide real-time feedback to the user in the steps of blocks 506 and 508. In block 518, the system may record and process results from the assessment with one or more non-transitory computer-readable memory components and/or any other suitable electronic component (e.g., processors) and provide said assessment results with visual and/or auditory feedback via the display. As noted previously, in some embodiments, the results may be sent to a remote clinician, as shown in block 519.

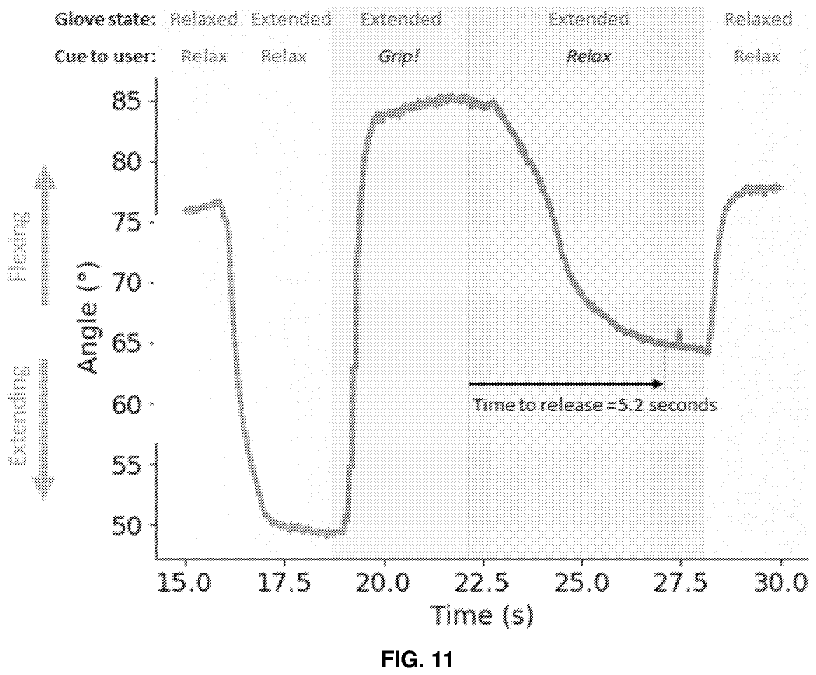

FIG. 11 shows, according to some embodiments, a plot of bending angle (derived from movement sensor data of one or more sensors on a wearable robotic system) as a function of time during a force response assessment. As shown in the figure, the time to release duration may be calculated between the relaxation cue after the user contracts their appendage (e.g., gloved hand) and when the user has relaxed said hand to a suitable relaxation threshold.

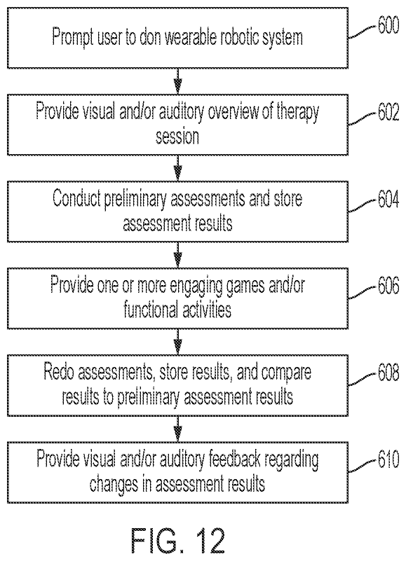

FIG. 12 shows, according to some embodiments, a flow chart for a rehabilitation session. The user may begin by powering up the system and ensuring the proper connections (physical and/or wireless) are formed. If the session is intended to be a telehealth session, the clinician (who may or may not be remotely located) may be connected into the system. The session may begin by prompting the user to don a wearable robotic system (e.g., a glove), as shown in block 600. The user may adjust the glove to better conform to their appendage (e.g., hand) for greater conformation and comfort throughout the session. In block 602, the system may provide the user with an overview of the rehabilitation session via the display. In block 604, the system may perform one or more preliminary assessments. For example, the system may perform a calibration assessment as shown in FIG. 4, one or more stretching assessments to prepare the user's hand for the session as shown in FIG. 6, one or more force assessments as shown in FIG. 8, one or more spasticity assessments, one or more force response assessments as shown in FIG. 10, combinations thereof, and/or any other suitable assessment. It should be appreciated that the user and/or clinician may choose to adjust the number, duration, order, and/or any other parameter of the assessments for the user's continued rehabilitation and comfort.

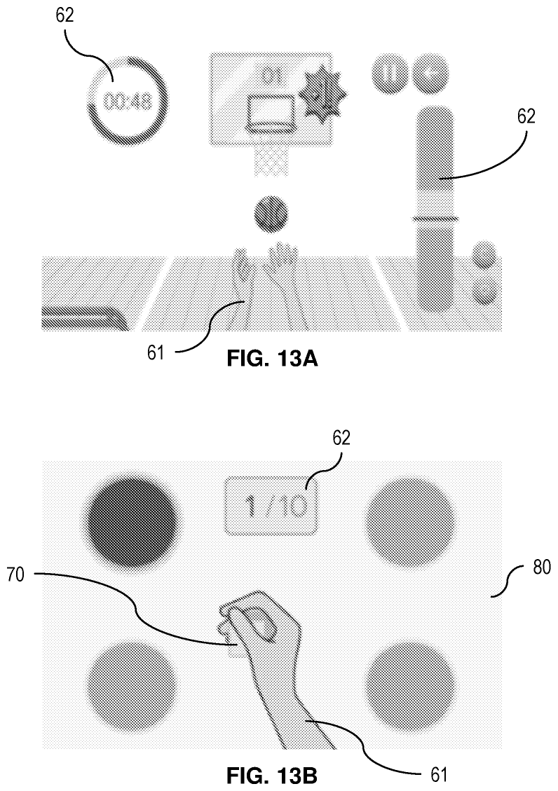

In block 606, the system may prompt the user to participate in one or more games and/or functional activities which may encourage the user to remain engaged in the rehabilitation session. FIGS. 13A-13B show, according to some embodiments, graphical interfaces for an exemplary game (FIG. 13A) and functional activity (FIG. 13B). The graphical interfaces may include animations 61 corresponding to the real-time movement of the glove (e.g., the bending angle of the glove measured by one or more movement sensors, which may be bend sensors), as well as instructions 62 or status/time indicators, as previously described. In some embodiments, the games and/or functional activities may employ a foam block 70 and training mat 80, as described in FIG. 1.

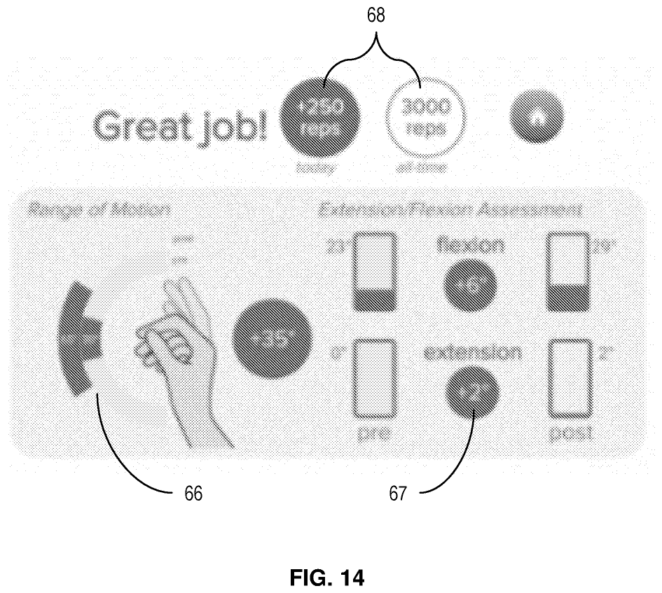

Turning back to FIG. 12, in block 608, the system may redo some or all of the preliminary assessments described in relation to block 604. The system may then compare results with the preliminary assessments to evaluate the progress of the user through this particular session and/or throughout their rehabilitation (e.g., compare results with prior rehabilitation sessions). In block 610, the system may then communicate said results to the user and/or clinician, to allow the parties to evaluate the session and adjust or modify the routine for the next session. FIG. 14 shows an exemplary user-friendly graphical interface displaying results of a rehabilitation session. The results may include one or more range of motion graphics 66, depicting progress in range of motion, one or more force graphics 67, depicting progress of extension/contraction force, one or more progress graphics 68, depicting general progress (e.g., through repetitions of a particular activity or total time spent on rehabilitation activities), and/or any other suitable graphic.

It should be appreciated that any other (compared to FIG. 12) clinically relevant order of the various assessments and activities of the rehabilitation session may also be employed, as the present disclosure is not so limited.

The Inventors have recognized that successful rehabilitation may require patient effort and engagement, which may result in successful neuroplasticity and recovery. Accordingly, the rehabilitation systems of the present disclosure may include one or more user engagement features to ensure the user is engaged and applying sufficient effort to warrant progress.

In some embodiments, a rehabilitation system may include movement intention detection to ensure that the user is initiating an activity. For example, when playing games and performing functional activities with the glove (see block 606 of FIG. 12 and FIGS. 13A-13B), the user may be required to initiate each movement. The amount of effort required to start the movements may be adapted to the user's capability throughout the session. In some embodiments, the intention detection may follow an algorithm which uses data from the one or more sensors of the wearable robotic system to determine if/when the user is attempting to extend or contract their appendage. For example, the algorithm may employ two low-pass filters, one at 5 Hz and the other at 1 Hz. The 5 Hz filter may be responsible for removing the noise from the sensor, while still being able to follow most hand movements from the user. The 1 Hz filter may be responsible for keeping track of a baseline hand position, for example when the user slowly moves from one hand posture to another. When the difference between the output of these two filters is measured to be higher than a threshold, an intention detection may be triggered. Of course, other suitable signal processing techniques to determine intention detection may also be employed, as the present disclosure is not so limited.

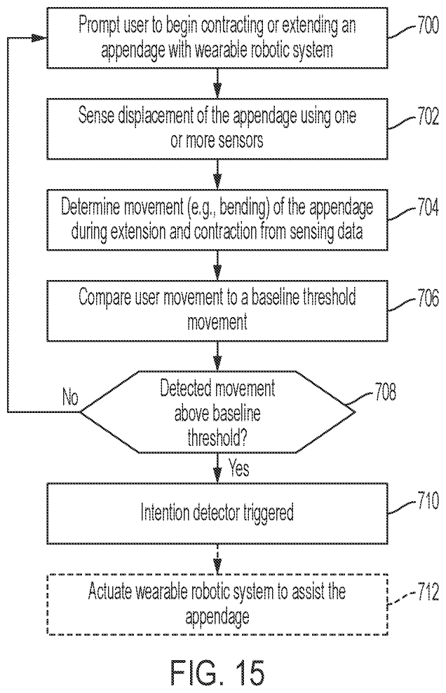

FIG. 15 shows, according to some embodiments, a block diagram of an intention detection algorithm. In block 700, a user may be prompted to begin a game or activity (or any other exercise) by extending or contracting their appendage with the wearable robotic system. In block 702, the system may measure or sense displacement of the appendage due to movement from the user using data collected by one or more sensors of the wearable robotic system. The system may then use the sensed data to determine a movement parameter (e.g., bending) of the appendage, as shown in block 704. In block 706, the movement data may then be compared with a baseline threshold value, as described with respect to the low-pass filters above. In block 708, the algorithm may determine whether or not the action that the user took in response to the prompt of block 700 was above the recorded baseline movement. If a suitable action was taken, then the intention detector may be triggered, as shown in block 710, and the exercise may begin. Once the intention detected is triggered, the glove may provide some assistance in performing the exercises, if the user is determined to require such assistance, as shown in block 712. This assistance may change over time as the user's condition changes. If a suitable action was not taken (e.g., user did not move their hand), then the system may prompt the user (block 700) and repeat the cycle until intentional movement is detected.

In some embodiments, a rehabilitation system may evaluate user engagement on a continuous basis during an exercise. The contribution of the user to an exercise may be verified to ensure user engagement throughout the duration of said exercise. In some embodiments, the continuous user engagement evaluation may follow the intention detection. To stimulate user engagement after the triggering of the intention detection, the total displacement generated by the wearable robotic system (e.g., glove) after pressurization may be compared to the movement obtained in the stretching assessment (when the user's appendage was relaxed) for a specific assistance level. When the user is engaged in the exercise, an increase in total range of motion may be detected, as the total movement of the glove is a combination of the movement created by the actuators in the glove and input from the user. If the user is not engaged, a prompt (visual, audible, and/or tactile) may request engagement from the user.

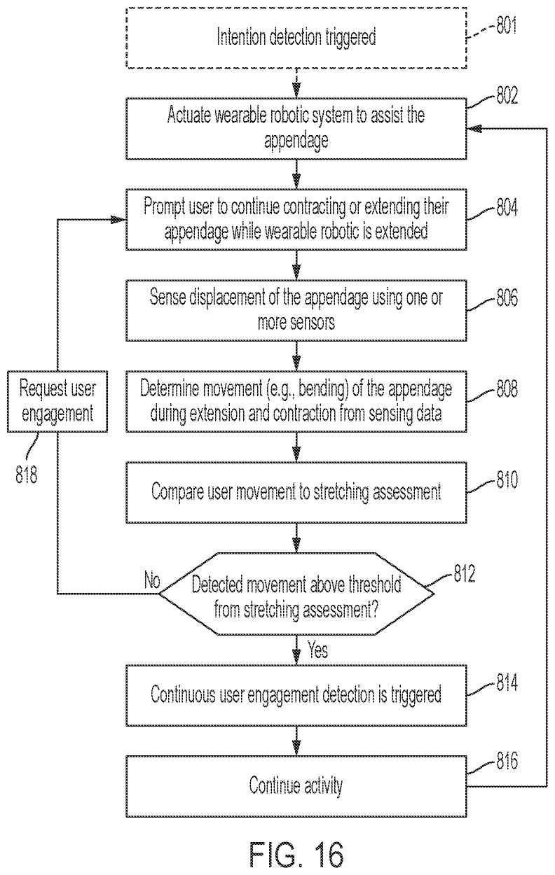

FIG. 16 shows, according to some embodiments, a block diagram of a continuous user engagement detection algorithm. In block 801, the algorithm may follow the triggering of an intention detection algorithm, as previously described with respect to FIG. 15. In some embodiments, the continuous user engagement algorithm may operate without the intention detection. In block 802, the system may actuate the wearable robotic system to assist the appendage in one or more exercises. The actuation of the wearable robotic system (e.g., glove) may facilitate the extension and/or contraction of an appendage (e.g., hand). In block 804, the system may prompt the user to continue engaging in an activity, game, and/or assessment by contracting or extending their gloved hand. The system may then sense displacement of the glove with one or more sensors, as shown in block 806, and use said sensor data to determine movement of the appendage during the exercise, as shown in block 808. In block 810, the total movement of the glove, which may be a combination of the user's engagement and the wearable robotic system actuation, may be compared to movement captured during a stretching assessment (e.g., as described with respect to FIG. 6). In block 812, the algorithm may determine whether or not the user is continuously engaging with the system. In some embodiments, if the total movement of the glove calculated in block 808 is equal to or less than movement measured in the stretching assessment, the system may determine that the user is not continuously engaging with the system. Thus, if continuous engagement is detected, then the continuous engagement detection may be triggered, as shown in block 814, and the exercise may continue, as shown in block 816. This process of blocks 802-816 may be repeated continuously during any given exercise to determine continuous engagement from the user. If continuous engagement is not detected, then the system may request user engagement (block 818) by prompting the user (block 804) using the display, and repeat the cycle until continuous intention is detected and maintained.

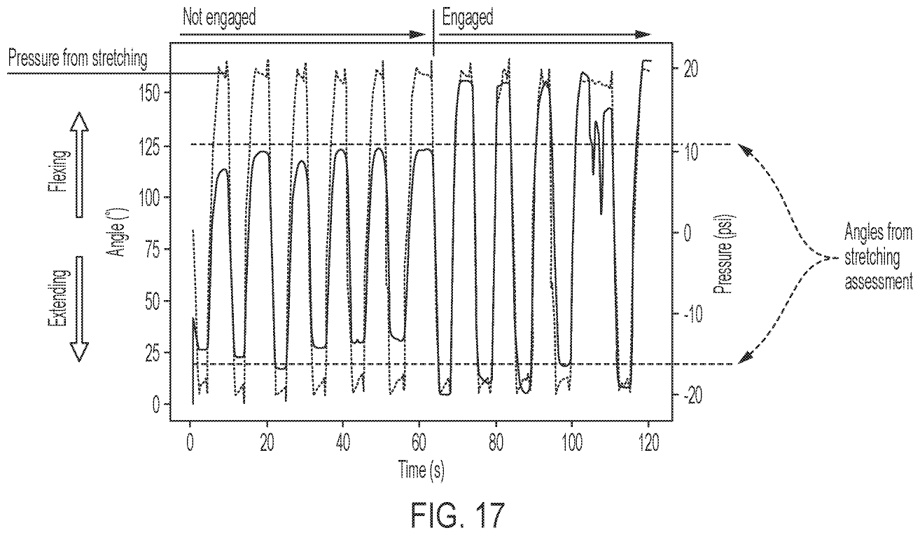

FIG. 17 shows, according to some embodiments, a plot of bend angle (from the movement sensors) as a function of time, during a continuous engagement detection algorithm. The user is determined to be engaged once the bend angles pass a threshold bend angle determined by the recorded stretching assessments described previously.

Having thus described several aspects of several embodiments of a rehabilitation system, it is to be appreciated that various alterations, modifications, and improvements will readily occur to those skilled in the art. Such alterations, modifications, and improvements are intended to be part of this disclosure, and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices.

These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

The section headings used are for organizational purposes only and are not to be construed as limiting the subject matter described in any way.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Any terms as used herein related to shape, orientation, alignment, and/or geometric relationship of or between, for example, one or more articles, structures, forces, fields, flows, directions/trajectories, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A wearable system for facilitating rehabilitation exercises, functional activity, and/or assessing activity quality, the wearable system comprising:
a flexible wearable robotic system configured to be worn on an appendage of a user, the flexible wearable robotic system including one or more compliant actuators configured to apply a force to one or more joints of the appendage;
one or more sensors configured to sense one or more parameters related to movement of the appendage; and
at least one processor operatively coupled with the one or more sensors and the one or more compliant actuators, wherein the at least one processor is configured to:
operate the one or more compliant actuators to perform one or more rehabilitation activities,
output feedback related to the one or more parameters to the user using a display operatively coupled to the at least one processor, and
determine intentional user engagement with the one or more activities with an intention detection algorithm configured to compare the one or more parameters with at least one baseline threshold parameter.

2. The wearable system of claim 1, wherein the at least one processor is configured to provide feedback in real-time.

3. The wearable system of claim 1, wherein the at least one processor is operatively coupled to non-transitory computer-readable memory comprising one or more instructions to perform the one or more rehabilitation activities.

4. The wearable system of claim 3, wherein the non-transitory computer-readable memory is configured to store the feedback, and wherein the at least one processor is configured to provide the feedback to the user on-demand.

5. (canceled)

6. (canceled)

7. The wearable system of claim 1, further comprising the display configured to communicate one or more prompts to the user to perform the one or more rehabilitation activities.

8. The wearable system of claim 1, wherein the one or more compliant actuators are configured to actively move the appendage when operated by the at least one processor.

9. The wearable system of claim 1, wherein the at least one processor is further configured to output the feedback related to the one or more parameters to a remote user.

10. The wearable system of claim 3, wherein the non-transitory computer-readable memory is configured to store the feedback, and wherein the at least one processor is configured to provide the feedback to a remote user in an on-demand manner.

11. The wearable system of claim 1, wherein the one or more rehabilitation activities comprises at least one force assessment configured to assess motor function of the appendage.

12. The wearable system of claim 1, wherein the one or more rehabilitation activities comprises at least one active assessment configured to assess movement of the one or more joints without actuation of the one or more compliant actuators.

13. The wearable system of claim 1, wherein the one or more parameters comprises a deformation and/or change in shape of at least one of the one or more compliant actuators.

14. The wearable system of claim 13, wherein the deformation comprises a bending angle of the at least one of the one or more compliant actuators.

15. (canceled)

16. The wearable system of claim 1, wherein the at least one processor is further configured to determine continuous user engagement with the one or more rehabilitation activities with a continuous engagement detection algorithm configured to compare the one or more parameters with at least one parameter measured by the one or more sensors when the flexible wearable robotic system actively actuates the one or more joints.

17. A method of rehabilitation comprising:
positioning a flexible wearable robotic system on an appendage of a user;
operating one or more compliant actuators of the flexible wearable robotic system with at least one processor operatively coupled to the one or more compliant actuators to apply a force to one or more joints of the appendage to perform one or more rehabilitation activities;
sensing one or more parameters related to movement of the appendage with one or more sensors of the flexible wearable robotic system;
outputting feedback related to the one or more parameters to a user using a display operatively coupled to the at least one processor; and
determining intentional user engagement with the one or more activities with an intention detection algorithm configured to compare the one or more parameters with at least one baseline threshold parameter.

18. The method of claim 17, wherein outputting feedback related to the one or more parameters comprises outputting real-time feedback to the user.

19. The method of claim 17, further comprising storing one or more instructions to perform the one or more rehabilitation activities in non-transitory computer-readable memory operatively coupled to the at least one processor.

20. The method of claim 19, further comprising:
storing the feedback in the non-transitory computer-readable memory, and
outputting the feedback to the user in an on-demand manner.

21. (canceled)

22. (canceled)

23. The method of claim 17, further comprising outputting one or more prompts to the user using the display to perform the one or more rehabilitation activities.

24. The method of claim 17, wherein operation of the one or more compliant actuators further comprises moving the appendage.

25. The method of claim 17, further comprising outputting the feedback related to the one or more parameters to a remote user.

26. The method of claim 19, further comprising:
storing the feedback in the non-transitory computer-readable memory, and
outputting the feedback to a remote user in an on-demand manner.

27. The method of claim 17, further comprising assessing motor function of the appendage during at least one force assessment.

28. The method of claim 17, further comprising assessing movement of the appendage during at least one active assessment configured to assess movement of the one or more joints without actuation of the one or more compliant actuators.

29. The method of claim 17, wherein operating the one or more compliant actuators further comprises deforming the one or more compliant actuators.

30. (canceled)

31. The method of claim 17, further comprising determining continuous user engagement with the one or more rehabilitation activities with a continuous engagement detection algorithm configured to compare the one or more parameters with at least one parameter measured by the one or more sensors when the flexible wearable robotic system actively actuates the one or more joints.

32. The method of claim 17, further comprising assessing at least one of spasticity, tone, and muscle rigidity with the flexible wearable robotic system.

33. The wearable system of claim 1, wherein the one or more sensors is an inertial measurement sensor.

34. The wearable system of claim 33, wherein the one or more sensors includes at least one inertial measurement sensor placed on a finger of the flexible wearable robotic system and at least one inertial measurement sensor placed on a hand of the flexible wearable robotic system, and wherein the at least one inertial measurement sensor on the finger and the at least one inertial measurement sensor on the hand are configured to measure relative movement between each other.

35. The wearable system of claim 1, wherein the intention detection algorithm is further configured to determine when the user attempts to initiate a movement by analyzing data from the one or more sensors to determine when the user is attempting to extend or contract the appendage.

36. The wearable system of claim 2, wherein the feedback provided in real-time includes an animation on the display representing a movement of the user or a progression of an exercise of the user.

37. The wearable system of claim 11, wherein during the at least one force assessment, the at least one processor is configured to:
operate the one or more compliant actuators to apply a resistance force; and
prompt the user to apply a maximum force in a direction opposing the resistance force.

38. The wearable system of claim 12, wherein the at least one active assessment is a calibration assessment to evaluate an active range of motion of the appendage by prompting the user to extend or contract the appendage to a greatest comfortable capacity.

39. The wearable system of claim 12, wherein data from the at least one active assessment is stored for comparison with data from other active assessments at an end of a rehabilitation session to monitor effects and progress of the rehabilitation session.
